(19) United States
(12) Patent Application Publication
(10) Pub. No.: US 2005/0263554 A1
(43) Pub. Date: Dec. 1, 2005

(54) SECURING DEVICE

(75) Inventors: Henrik Naslund, Jonkoping (SE); Andreas Arvidsson, Varnamo (SE); Anders Nilsson, Varnamo (SE)

Correspondence Address: NOVAK DRUCE & QUIGG, LLP, 1300 EYE STREET NW, 400 EAST TOWER, WASHINGTON, DC, 20005, US

(73) Assignee: THULE SWEDEN AB, Hillerstorp (SE)

(21) Appl. No.: 10/907,645

(22) Filed: Apr. 9, 2005

Related U.S. Application Data
(63) Continuation of application No. PCT/SE03/01468, filed on Sep. 19, 2003.

(30) Foreign Application Priority Data
Oct. 9, 2002 (SE) 0202969-2

(51) Int. Cl. B60R 9/00

(52) U.S. Cl. 224/319; 224/321; 224/924

(57) ABSTRACT

A securing device (4) usable in conjunction with a load carrier (1) and with which the load carrier is attached to a load carrier bar (5) mounted on a vehicle. Most frequently, such load carrier bars (5) are located on the roof (7) of a vehicle by way of mounting devices (6). Exemplarily, such securing device includes a base part (8) having an essentially flat face (9) designed to be placed on the load carrier bar. A clamping yoke (10) is also included that encloses the load carrier bar and which, at a first end (11) has a pivot arrangement (12) that is pivotably engaged with the base part. At a second end, clamping yoke (10) is attached to the base part by a tightening device (15) which tightens the clamping yoke about the load carrier bar and wherein the clamping yoke (10) is provided with a bow-shaped contact area (21) for engagement with the load carrier bar (5).

### CROSS-REFERENCE TO RELATED APPLICATIONS

The present application is a continuation patent application of International Application No. PCT/SE2003/01 468 filed 19 Sep. 2003 which was published in English pursuant to Article 21(2) of the Patent Cooperation Treaty, and which claims priority to Swedish Application No. 0202969-2 filed 9 Oct. 2002. Said applications are expressly incorporated herein by reference in their entireties.

### FIELD OF THE INVENTION

The present invention relates to a securing device used in conjunction with a load carrier, exemplarily attached to load carrier bars mounted on a vehicle, usually at the roof by means of mounting devices, More particularly, the securing device comprises (includes, but is not necessarily limited to) a base part having an essentially flat face designed to be placed on the load carrier bar and a clamping yoke that encloses the load carrier bar and which, at a first end, is pivotably engaged with the base part and at a second end is attached to the base part by means of a tightening device for the purpose of tightening the clamping yoke about the load carrier bar.

### BACKGROUND OF THE INVENTION

Securing devices of the type described are already known and are available in various designs. However, the disadvantage of such existing designs is that, in order to ensure tight and secure attachment of the securing device to the load carrier bar, the clamping yoke must be designed to fit the load carrier bar. This means that a number of different securing devices must be available since load carrier bars of various designs are available on the market. This creates a risk that a load carrier may be attached to a load carrier bar using a securing device which is not designed for the particular load carrier bar shape, especially if the operator is unfamiliar with the equipment (for instance, if the load carrier is lent to another by the owner) and potentially resulting with the load carrier becoming loosened from the load carrier bars.

Thus, there exists a need for a securing device of the type described above, but which is designed in such manner that it can safely be attached to a load carrier bar regardless of the design (shape) of the load carrier bar.

### SUMMARY OF THE INVENTION

The present invention overcomes the problem described above by means of a securing device of the type described in the introduction, and which is characterized by the fact that the clamping yoke is provided with a contact area of arched shape for engagement with the load carrier bar.

In a preferred embodiment, the present invention is further characterized in that the contact area is of a circular shape. Alternatively, the invention can be characterized in the fact that the contact area is of a pointed arch shape. In still another exemplary configuration, the contact area of the clamping yoke begins and ends at points which, when the clamping yoke is tightened about the load carrier bar, are located respectively between the base part and the tangent to the point on the load carrier bar which is furthest from the base part.

### BRIEF DESCRIPTION OF THE DRAWINGS

Exemplary and preferred embodiments of the invention are described hereinbelow, and in which reference is made to the illustrative drawings appended hereto, and in which:

FIG. 1 is a side elevational view of a load carrier attached to load carrier bars mounted on a vehicle roof;

FIG. 2 is a perspective view from above showing the load carrier attached to the load carrier bars;

FIG. 3 is a detail view of a securing device configured according to the teachings of the present invention, in a fully open position;

FIG. 4 is a view corresponding to FIG. 3, but in which the clamping yoke is connected to the tightening device;

FIG. 5 is a view corresponding to FIG. 3, but in which the tightening device has been tightened bring the clamping yoke into partial contact with the load carrier bar;

FIG. 6 is a view in which the tightening device is in the fully tightened configuration (position);

FIGS. 7-8 are views showing a similarly configured tightening device, but on different load carrier bars of two different profiles; and

FIGS. 9-11 are views showing alternatively configured clamping yoke shapes which serve as examples of configurations contemplated within the scope of the present invention.

### DETAILED DESCRIPTION

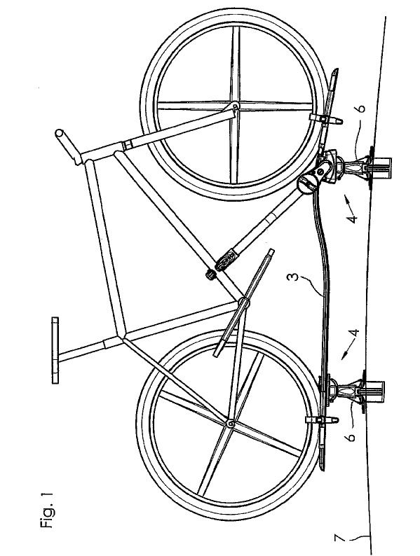

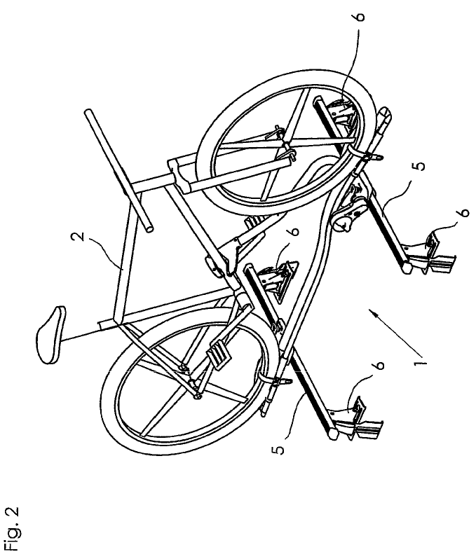

FIGS. 1 and 2 show a load carrier 1 on which a bicycle 2 is loaded. The load carrier 1 is provided with a rail 3 to which securing devices 4, for attaching the load carrier 1 to load carrier bars 5, are connected in a known manner. As shown schematically in FIG. 1, the load carrier bars 5 are mounted on a vehicle roof 7 by means of mounting devices 6.

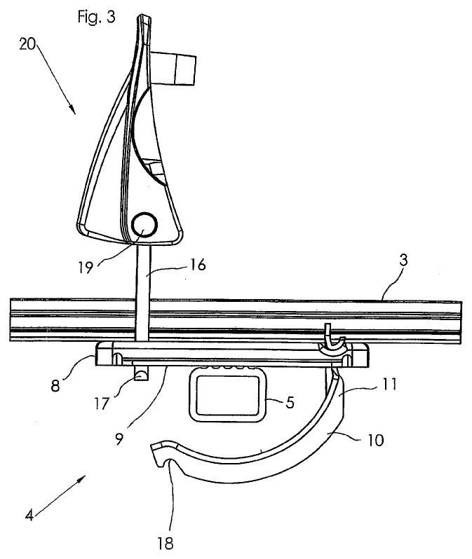

The securing device in accordance with the present invention is shown in greater detail in FIGS. 3-6. The figures also show part of the rail 3, which is attached to the securing device in a manner known to those skilled in the art, and which will therefore not be described in greater detail herein.

The securing device is provided with a base part 8 with an essentially flat surface 9 which is placed on a load carrier bar 5. Although the load carrier bar shown in the figures is of rectangular cross-section, it should be appreciated that the present invention is independent of the cross-sectional shape of the load carrier bar 5. Furthermore, in the context of the present invention, the term ‘essentially’ should be interpreted as being those configurations as specifically characterized, as well as those which are similar, but do not functionally alter the so-described element.

The base part 8 is provided with a clamping yoke 10. At one end 11, the clamping yoke is pivotably connected to the base part 8 by means of a pivot arrangement 12 including a pivot pin 13 having a section of the clamping yoke 10 formed into a U-shape that rests in a cradle 14 formed in the base part 8. At a second end, the clamping yoke 10 is attached to the base part by means of a tightening device 15, which includes a pull rod 16 with a hook-shaped end 17 that engages in a shaped recess 18 in the clamping yoke 10.

At the end 19 opposite to the hook-shaped end, the pull rod 16 is attached pivotably to the a lever arrangement 20. This configuration enables the pull rod to be moved, in a known manner, in a direction toward and away from the base part 8 which causes the clamping yoke 10, when engaged with the pull rod, to be tightened about the load carrier bar 5 in a manner which will be described below.

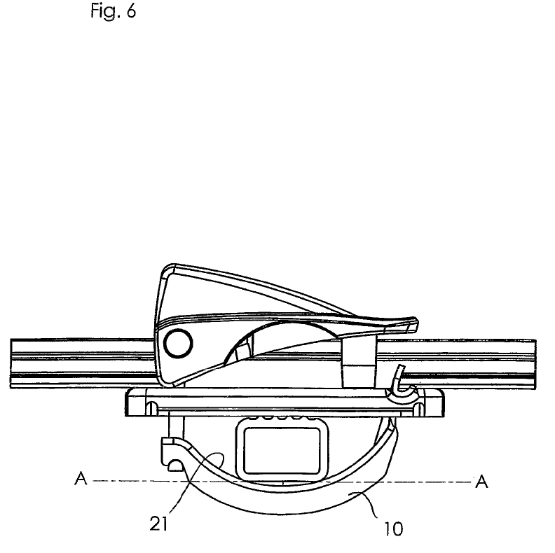

The clamping yoke 10 is provided with a contact area 21, which is of arched shape and along which contact between the load carrier bar and clamping yoke will occur when the clamping yoke is tightened against the base part. The dash-dotted line A-A in FIG. 6 indicates the tangent to the point on the load carrier bar 5 which is situated furthest from the base part and, as can be also be appreciated in FIG. 6, the contact area of the clamping yoke begins and ends at points located between the base part and the tangent A-A when the clamping yoke is tightened against the base part 8.

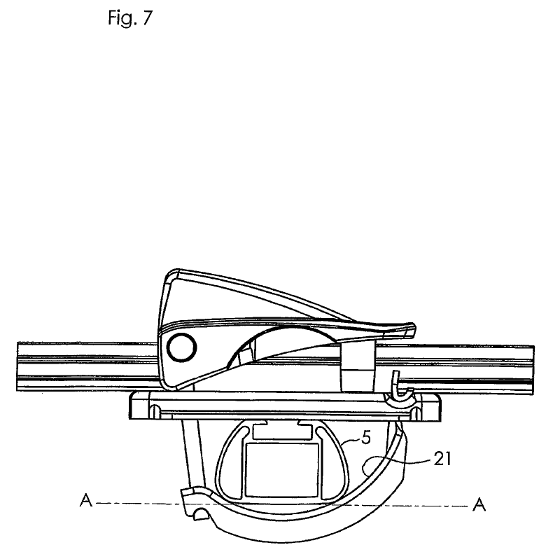

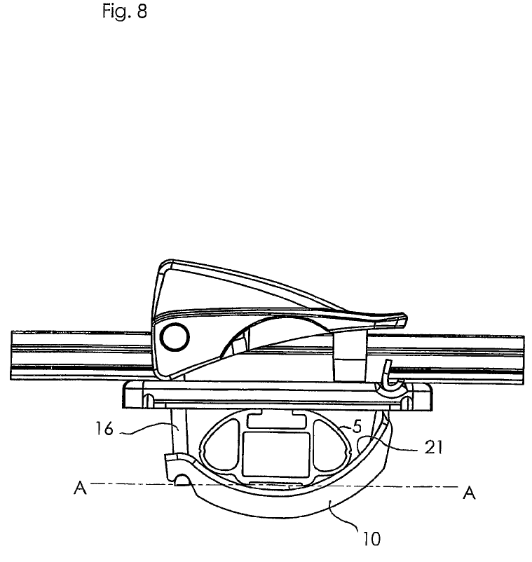

Alternative versions of the load carrier bar 5 are shown in FIGS. 7 and 8, and in which the clamping yoke is seen in the tightened position corresponding to that shown in FIG. 6. Furthermore, as can be seen in this case, the contact area 21 of the clamping yoke begins and ends at points located between the tangent A-A and the base part 8.

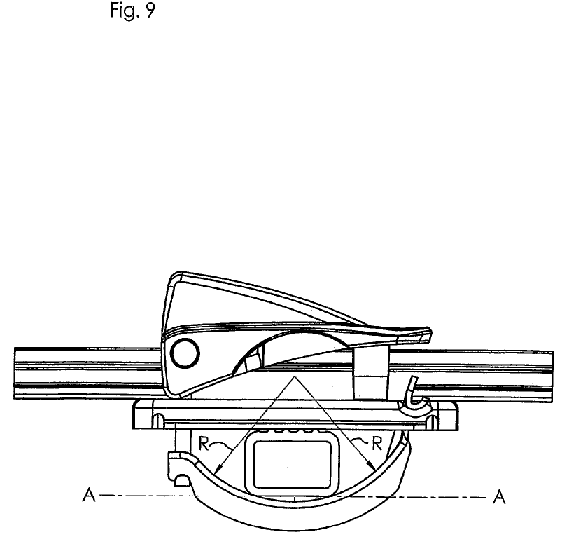

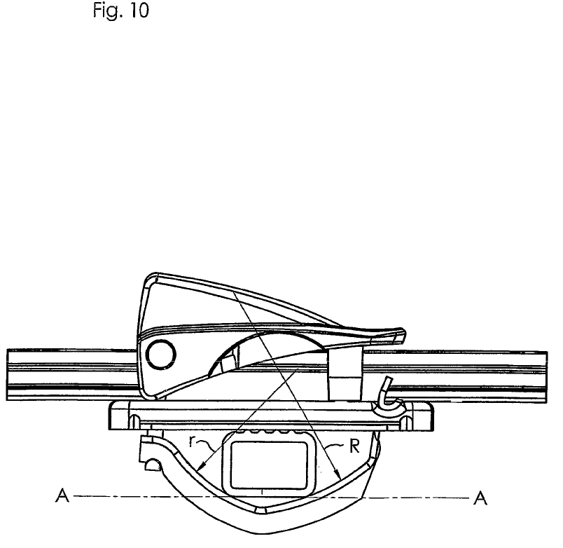

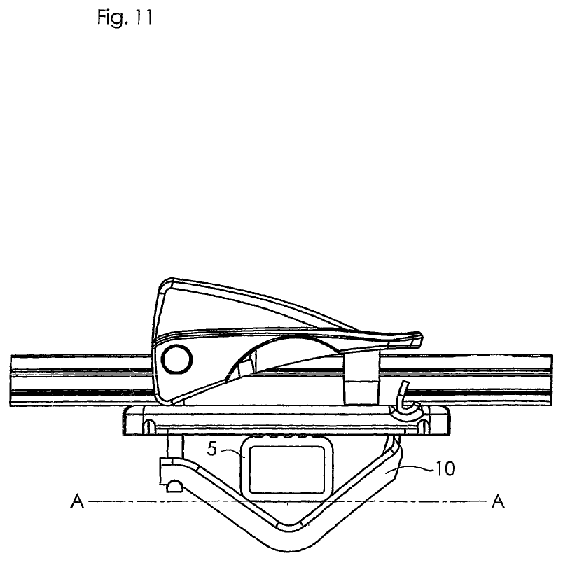

FIGS. 9-10 show different versions of the clamping yoke 10. In FIG. 9, the contact area on the clamping yoke is substantially circular in shape. In FIG. 10, the contact area on the left of the figure is of smaller radius than the area on the right of the figure, and which is indicated by the radii ‘R’ and ‘r’ respectively. The contact area is therefore bow-shaped, whereas in FIG. 11 the contact area is of a pointed arch-shape. As can be clearly appreciated from the several figures, the different versions of the invention that are shown are also provided with contact areas which begin and end at points located between the base part 8 and the tangent A-A.

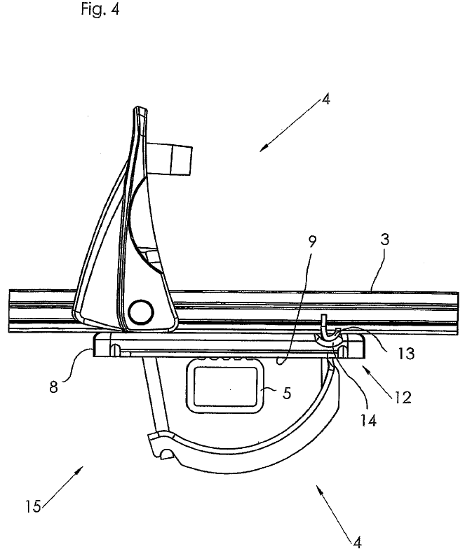

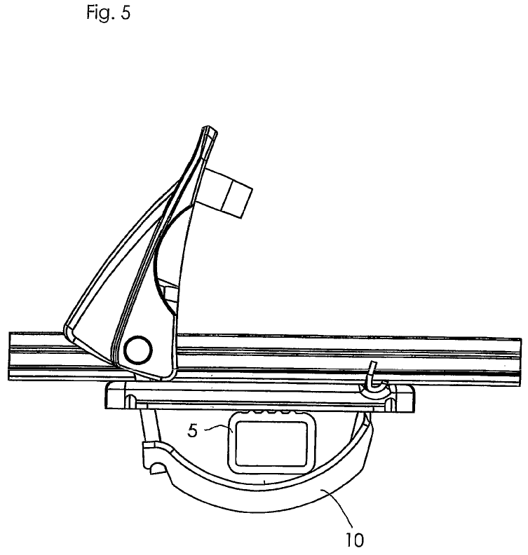

The operation of the securing device will hereinafter be described with reference to FIGS. 1-6. To mount a load carrier 1 on the load carrier bars 5, the load carrier is lifted onto the load carrier bars and the base parts of the respective securing devices are placed on the load carrier bars. At this point, the clamping yoke 10 is disengaged from the pull rod 16 in the manner illustrated in FIG. 3. The clamping yoke 10 is then connected to the pull rod 16 as shown in FIG. 4, and which causes the lever arrangement 20 to pivot in the manner shown in FIGS. 5 and 6, and which causes the clamping yoke 10 to turn about the pivot point 12 and move into contact with the base part 8. As shown in FIG. 5, the clamping yoke first comes in contact with the side of the load carrier bar located closest to the pivot point 12. Further, it will be clear to those skilled in the art that in order for the clamping yoke to be tightened to the position shown in FIG. 6, relative displacement must occur between the base part and the load carrier bar in such manner that the load carrier bar moves to the left in FIG. 5 relative to the base part 8. This may be achieved either by moving the entire load carrier or moving the base part along the rail 3. When the clamping yoke has been tightened to the position shown in FIG. 6, the arrangement will be clamped securely to the load carrier bar, regardless of the shape of the load carrier bar.

As illustrated in the figures, the contact areas of the various clamping yokes are designed to extend along the entire length of the clamping yoke. However, as explained above, it is sufficient for the contact area to begin and end at points located respectively between the base part and the tangent to the point on the load carrier bar situated furthest from the base part.

1. A securing device (4) for use between a load carrier (1) and a load carrier bar (5) mounted on a vehicle, said securing device comprising:
a base part (8) having an essentially flat face (9) configured for placement upon a load carrier bar;
a clamping yoke (10 ) that encloses the load carrier bar and which, at a first end (11) is pivotably engaged with the base part by a pivot arrangement (12) and, at a second end, is attached to the base part by a tightening device (15) for the purpose of tightening the clamping yoke about the load carrier bar; and
said clamping yoke (10) being provided with a bow-shaped contact area (21) that is configured for engagement with the load carrier bar (5).

2. The securing device as recited in claim 1, wherein the contact area (21) is circular in shape.

3. The securing device as recited in claim 1, wherein the contact area (21) is pointed arch-shaped.

4. The securing device as recited in claim 1, wherein the contact area (21) begins and ends at points that, when the clamping yoke (10 ) is tightened about the load carrier bar, are located respectively between the base part (8) and a tangent extending between a point on the load carrier bar (5) situated furthest from the base part (8).
